(19) United States
(12) Patent Application Publication
(10) Pub. No.: US 2009/0047829 A1
(43) Pub. Date: Feb. 19, 2009

(54) UNSHIELDED RJ STYLE CONNECTOR TO ELIMINATE CABLE ELECTROSTATIC DISCHARGE EVENTS

(75) Inventors: Frederic Michael Kozak, Raleigh, NC (US); Stephen Aubrey Scearce, Apex, NC (US); Milton Palmer Hilliard, Hillsborough, NC (US); Samuel McCloy Lyall, Danville, CA (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(73) Assignee: CISCO TECHNOLOGY, INC., San Jose, CA (US)

(21) Appl. No.: 11/837,809

(22) Filed: Aug. 13, 2007

(51) Int. Cl. H01R 13/648

(52) U.S. Cl. 439/607; 361/212

(57) ABSTRACT

In one embodiment, an apparatus includes at least one signal contact, a housing, and a discharge circuit arrangement. The housing defines a receptacle configured to receive a part of a cable assembly. The signal contact is disposed within the receptacle, and is configured to contact a first contact of the cable assembly when the cable assembly is received in the receptacle such that a signal may pass between the at least one signal contact and the first contact. The discharge circuit arrangement is at least partially disposed on the housing, and includes at least one discharge conductor that contacts the first contact and discharges an electrical charge associated with the first contact through a discharge circuit before the first contact contacts the signal contact.

### CROSS REFERENCE TO RELATED APPLICATION

The present application is related to U.S. patent application Ser. No. 11/669,330, filed Jan. 31, 2007, which is incorporated herein by reference in its entirety.

### BACKGROUND OF THE INVENTION

The connection of cables to ports on electronic equipment, e.g., network equipment, often causes electrostatic discharge (ESD) events. An ESD event is generally a flow of an electric current from one potential to another that may damage electronic equipment. To prevent ESD events, persons handling cables may take precautions such as wearing conductive wrist straps and working in electrostatic protective areas. However, even with the proper handling of cables, electron accumulation often occurs on the cables and, hence, ESD events occur when the cables are plugged into ports on electronic equipment.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a diagrammatic perspective representation of a first modified RJ connector with bleed circuit conductors in accordance with an embodiment of the present invention.

FIG. 1B is a diagrammatic cross-sectional side view representation of a modified RJ connector, i.e., modified RJ connector 1 of FIG. 1A, in accordance with an embodiment of the present invention.

FIG. 2. is a diagrammatic representation of a second modified RJ connector in accordance with an embodiment of the present invention.

FIG. 3A is a block diagram representation of an RJ connector assembly that includes a bleed circuit and is arranged to receive a cable connector in accordance with an embodiment of the present invention.

FIG. 3B is a block diagram representation of an RJ connector assembly that includes components of a bleed circuit and is arranged to receive a cable connector in accordance with an embodiment of the present invention.

FIG. 3C is a block diagram representation of an RJ connector assembly that includes an interface to a bleed circuit and is arranged to receive a cable connector in accordance with an embodiment of the present invention.

FIG. 4A is a block diagram representation of a cable in contact with bleed circuit conductors in an RJ connector assembly, e.g., bleed circuit conductors 204 of RJ connector assembly 200 of FIG. 3A, in accordance with an embodiment of the present invention.

FIG. 4B is a block diagram representation of a cable seated in an RJ connector assembly, e.g., RJ connector assembly 200 of FIG. 3A, in accordance with an embodiment of the present invention.

FIG. 5 is a process flow diagram which illustrates one method of plugging a cable into an RJ connector assembly that includes bleed circuit conductors in accordance with an embodiment of the present invention.

FIG. 6A is a block diagram representation of an RJ connector assembly which includes an adapter that has bleed circuit conductors and a bleed circuit in accordance with an embodiment of the present invention.

FIG. 6B is a block diagram representation of an RJ connector assembly which includes an adapter that has bleed circuit conductors and a partial bleed circuit in accordance with an embodiment of the present invention.

FIG. 6C is a block diagram representation of an RJ connector assembly which includes an adapter that has bleed circuit conductors and an interface to an external bleed circuit in accordance with an embodiment of the present invention.

FIG. 7 is a block diagram representation of an adapter with bleed circuit conductors, e.g., adapter 420 of FIG. 6A in accordance with an embodiment of the present invention.

FIG. 8 is a diagrammatic representation of a first RJ connector assembly that includes an adapter with bleed circuit conductors in accordance with an embodiment of the present invention.

FIG. 9 is a diagrammatic representation of a first RJ connector assembly that includes an adapter with bleed circuit conductors in accordance with an embodiment of the present invention.

### DESCRIPTION OF EXAMPLE EMBODIMENTS

### General Overview

According to one aspect of the present invention, an apparatus includes at least one signal contact, a housing, and a discharge circuit arrangement. The housing defines a receptacle configured to receive a part of a cable assembly. The signal contact is disposed within the receptacle, and is configured to contact a first contact of the cable assembly when the cable assembly is received in the receptacle such that a signal may pass between the at least one signal contact and the first contact. The discharge circuit arrangement is at least partially disposed on the housing, and includes at least one discharge conductor that contacts the first contact and discharges an electrical charge associated with the first contact through a discharge circuit before the first contact contacts the signal contact.

### DESCRIPTION

RJ connectors are often used to connect or otherwise terminate cables that are used in telecommunications applications. RJ style connectors may include, but are not limited to, RJ-11, RJ-21, and RJ-45 connectors. A modified RJ connector or an overall RJ connector assembly that includes the ability to “bleed off,” or otherwise discharge, electron build up in a cable reduces the risk of an electrostatic discharge (ESD) event. Allowing contacts of a cable to effectively be interfaced or coupled with a bleed circuit prior to the cable being seated within the connector assembly, i.e., such that the contacts of the cable are interfaced with contacts of the connector assembly, enables accumulated electron build up to be discharged. When a cable makes contact with conductors that are coupled to a bleed circuit, substantially any electron build-up in the cable may be bled from the cable. That is, a significant portion of any charge stored on the cable may effectively be eliminated. Hence, when the cable or, more specifically, the contacts of the cable come into contact with the contacts of the connector assembly, the risk of an ESD event occurring is relatively low.

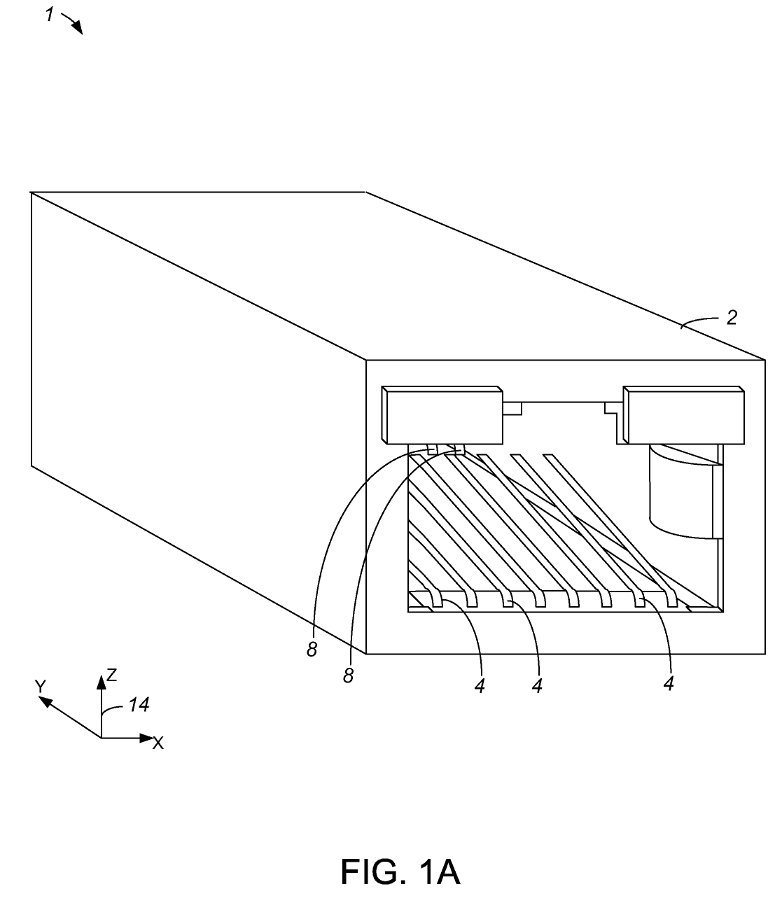

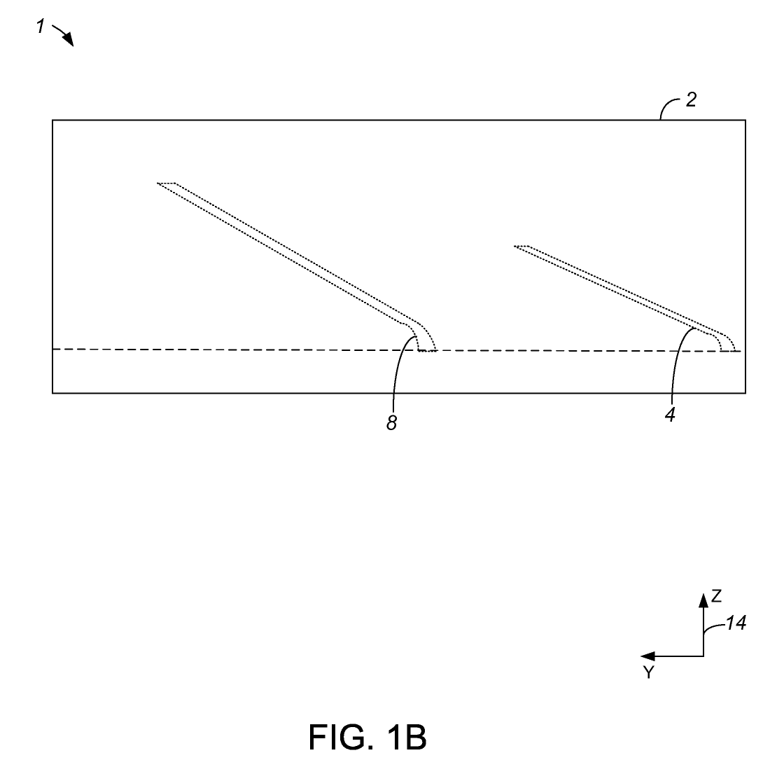

With reference to FIGS. 1A and 1B, one example of an RJ connector with discharge circuit or bleed circuit conductors will be described in accordance with a first embodiment of the present invention. FIG. 1A is a perspective representation of an RJ connector 1, while FIG. 1B is a cross-sectional side view representation of RJ connector 1. RJ connector 1 includes a housing 2 and a plurality of electrical contacts 8. Housing 2 is generally a shell into which a cable (not shown) may be received and held. That is, housing 2 defines a receptacle or a receiver for a cable (not shown). When a cable (not shown) is held within housing 2, electrical contacts of the cable are positioned in contact with contacts 8, e.g., an array of contacts, disposed in housing 2 such that streams or signals may flow between the electrical contacts of the cable and contacts 8. Typically, contacts 8 are communicably coupled to elements or components of an electronic device for which connector 1 serves as a port. By way of example, contacts 8 may be coupled to wires and/or leads which connect to devices on a printed circuit board or a line card on which connector 1 is supported. Signals such as data signals may pass between contacts 8 and devices on the printed circuit board or the line card.

Connector 1, which may be unshielded in the described embodiment, also includes bleed circuit contacts or conductors 4 which are positioned at an entrance to connector 1 or, more specifically, the entrance to a receptacle defined by housing 2. In other words, bleed circuit conductors 4 are positioned such that a electrical contacts of a cable (not shown) that is being plugged into connector 1 will come into contact with bleed circuit conductors 4 prior to coming into contact with contacts 8.

In one embodiment, bleed circuit conductors 4 are positioned at a front portion of housing 2. To accommodate bleed circuit conductors 4, and connector 1 may have a larger footprint than that of a standard connector. By way of example, if conductors 8 are sized and positioned such that connector 1 is an embodiment of an RJ-11 connector, then connector 1 may have a larger footprint than a standard RJ-11 connector.

Bleed circuit conductors 4 may be metallized, and are generally arranged such that when a force is imparted on bleed circuit conductors 4 in a z-direction 14 by electrical contacts of a cable (not shown), bleed circuit conductors 4 may deflect, and also provide a resistive force. The ability of bleed circuit conductors 4 to deflect upon contact and provide a resistive force effectively ensures that bleed circuit conductors 4 make at least some physical contact with electrical contacts of a cable (not shown) when the cable is plugged into housing 2.

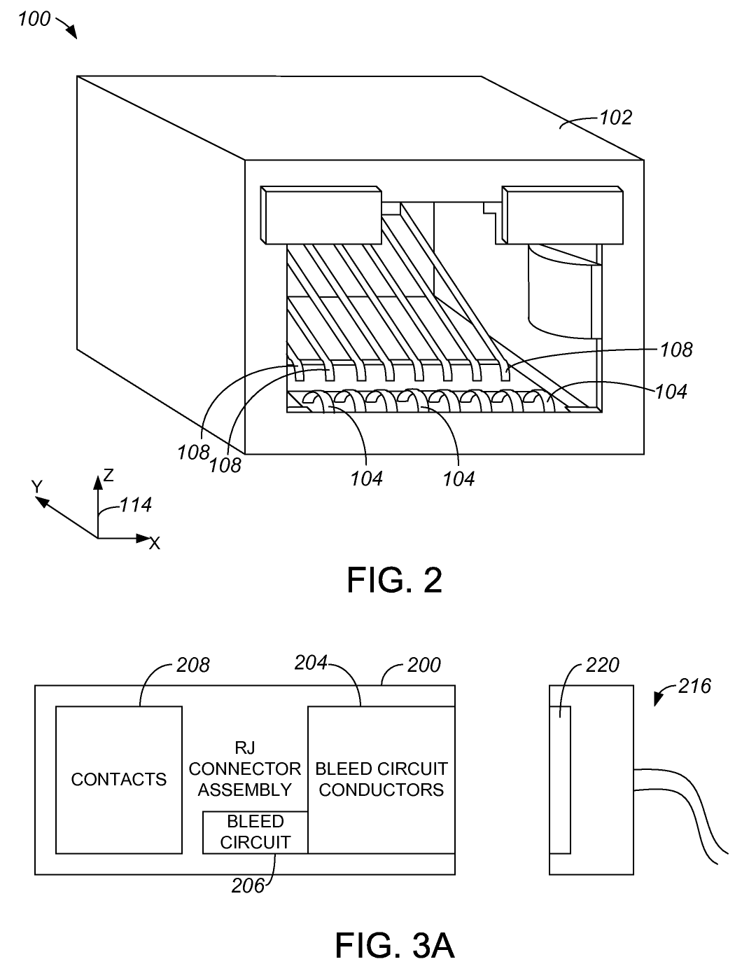

As previously mentioned, connector 1 may have a slightly larger footprint than a corresponding standard connector. To reduce the footprint of a connector that includes bleed circuit conductors, the size, shape, and/or orientation of the bleed circuit conductors may be varied. Referring next to FIG. 2, an RJ connector with bleed circuit conductors will be described in accordance with a second embodiment of the present invention. An RJ connector 100 includes a housing 102, electrical contacts 108, and bleed circuit conductors 104.

Bleed circuit conductors 104 are positioned at an entrance to connector 100 or, more specifically, the entrance to a receptacle defined by housing 102. In other words, bleed circuit conductors 104 are positioned such that a electrical contacts of a cable (not shown) that is being plugged into connector 100 will come into contact with bleed circuit conductors 104 prior to coming into contact with contacts 108. In the embodiment as shown, bleed circuit conductors 104 are positioned at a front edge of housing 102 and sized such that connector 100 has substantially the same footprint as a standard connector 100. By way of example, if connector 100 is an RJ-11 connector, then connector 100 has substantially the same external dimensions as a standard RJ-11 connector.

In general, bleed circuit conductors 104 may be metallized and relatively flexible. By way of example, bleed circuit conductors 104 may be arranged such that when a force is imparted on bleed circuit conductors 104 in a z-direction 114 by electrical contacts of a cable (not shown), bleed circuit conductors 104 may slightly deform, and provide a restraining force in z-direction 114 that substantially counteracts the force applied by the cable. The flexibility of bleed circuit conductors 104 effectively ensures that bleed conductors 104 will contact recessed electrical contacts of a cable (not shown) during the insertion of the cable into housing 100, and allow for the cable to be seated within housing 100 once insertion is complete.

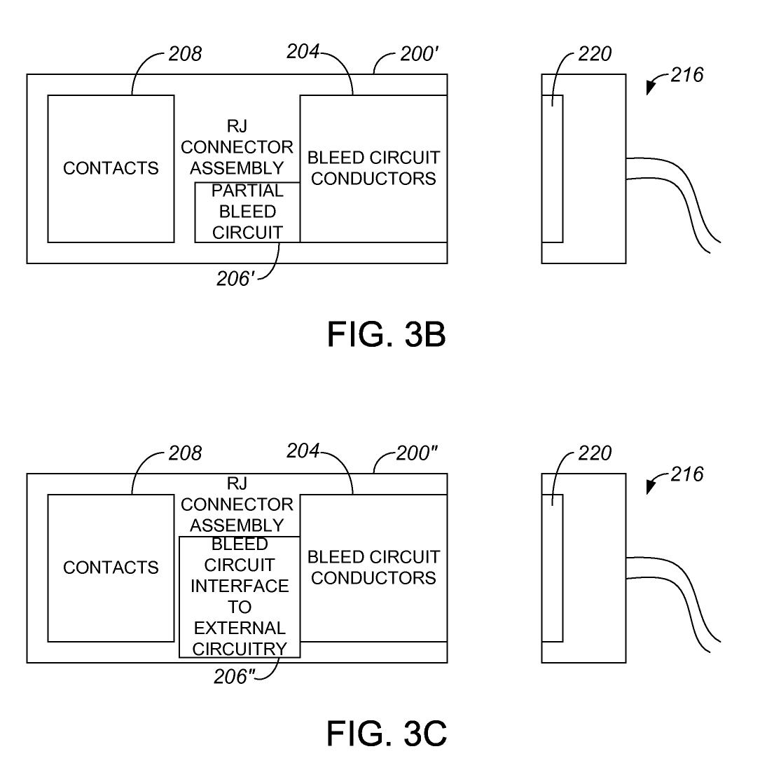

FIG. 3A is a block diagram of a cable and a connector assembly that includes bleed circuit conductors in accordance with an embodiment of the present invention. A connector assembly 200 is arranged to receive a cable 216 that includes contacts 220. Connector assembly 200 includes bleed circuit conductors 204 that are arranged to allow accumulated electron charge on contacts cable 216 to be bled off when contacts 220 contact bleed circuit conductors 204. Bleed circuit conductors 204 are coupled to a discharge circuit or a bleed circuit 206 which is included in connector assembly 200. As will be appreciated by those skilled in the art, bleed circuit 206 generally includes components which provide electron discharge capabilities, such as capacitive components, resistors, and/or semiconducting devices. That is, bleed circuit 206 may be an ESD protection circuit that drains the electrical charge that is accumulated on cable 216, and effectively provides a route through which a current caused by a voltage surge may be discharged. Bleed circuit 206 is configured to essentially minimize the occurrence of arcing when contacts 220 interface with contacts 208.

In general, bleed circuit conductors 204 are arranged to effectively be coupled to any suitable bleed circuit. A suitable bleed circuit 206 may be included in connector assembly 200. Other suitable bleed circuits may include, but are not limited to including, a bleed circuit that is partially embodied on a connector assembly and partially embodied on a printed circuit board with which the connector assembly is interfaced, and a bleed circuit that is substantially completely embodied on a printed circuit board with which the connector assembly is interfaced. A connector assembly that includes a portion of a bleed circuit will be described with respect to FIG. 3B, while a connector assembly that does not include components of a bleed circuit will be described with respect to FIG. 3C.

FIG. 3B is a block diagram representation of an RJ connector assembly that includes part of a bleed circuit and is arranged to receive a cable connector in accordance with an embodiment of the present invention. A connector assembly 200′ is arranged to receive cable 216. Bleed circuit conductors 204 are coupled to a partial bleed circuit 206′ such that when contacts 220 make contact with bleed circuit conductors 204, electron build up that is accumulated in cable 216 may be discharged through bleed circuit conductors 204 to partial bleed circuit 206′. Partial bleed circuit 206′ cooperates with circuitry on a printed circuit board, e.g., a printed circuit board on which connector assembly 200′ may be mounted, to form an overall bleed circuit.

FIG. 3C is a block diagram representation of an RJ connector assembly that includes an interface to a bleed circuit that is external to the RJ connector assembly, and is arranged to receive a cable connector in accordance with an embodiment of the present invention. A connector assembly 200″ is arranged to receive cable 216, and includes bleed circuit conductors 204 that are coupled to a bleed circuit interface 206″. Bleed circuit interface 206″ is, in one embodiment, an electrical an/or physical interface to a bleed circuit that is not included on connector assembly 200″. Hence, when contacts 220 come into contact with bleed circuit conductors 204, electrons accumulated in cable 216 may be bled off by an external bleed circuit that is accessed through bleed circuit interface 206″.

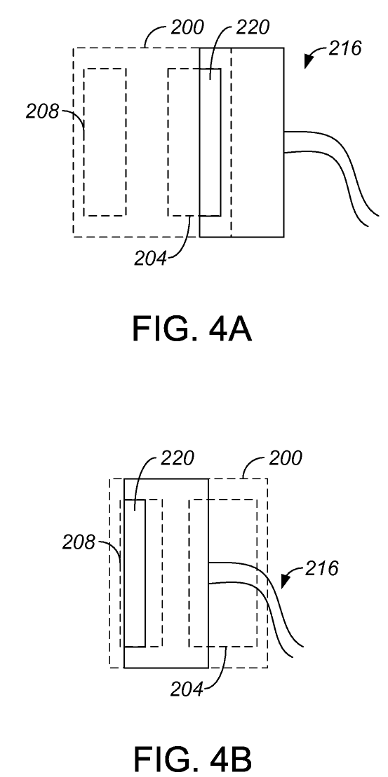

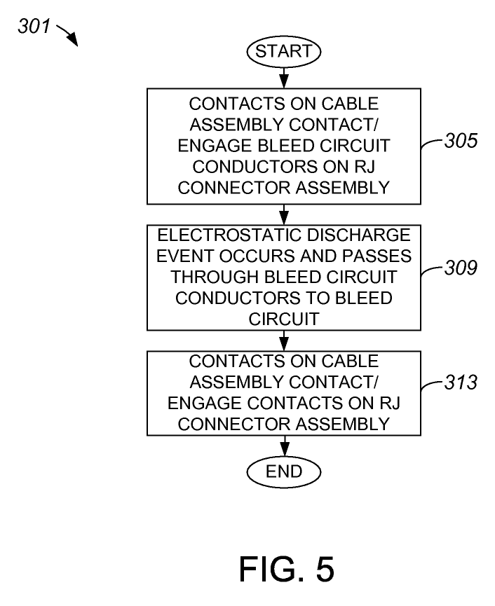

With reference to FIG. 4A, contact between a cable and bleed circuit conductors in an RJ connector assembly, e.g., bleed circuit conductors 204 of RJ connector assembly 200 of FIG. 3A, will be described in accordance with an embodiment of the present invention. Contacts 208 are arranged to substantially engage with contacts 220 when a head-end of cable 216 is positioned within assembly 220, as previously mentioned. When an insertion of cable 216 into connector assembly 200 begins, contacts 220 of cable 216 come into contact with bleed circuit conductors 204 of connector assembly 200. Bleed circuit conductors 204 provide a path to a bleed circuit (not shown) which may be embodied in connector assembly 200, partially embodied in connector assembly 200 and partially embodied in another component (not shown), or more than partially embodied in another component (not shown). Electrical charge that is built up in cable 216 may essentially flow to a bleed circuit (not shown) upon contact of contacts 220 with bleed circuit conductors 204.

Further inserting cable 216 into connector assembly 200 allows contacts 220 of cable 216 to engage with contacts 208 of connector assembly 220. FIG. 4B depicts cable 216 seated in connector assembly 200 in accordance with an embodiment of the present invention. Because electrical charge that was stored in cable 216 is substantially discharged when contacts 220 contact bleed circuit conductors 204, an ESD event is not likely to occur when contacts 220 engage with contacts 208, as substantially any stored charge has already been discharged through bleed circuit conductors 204.

In the embodiment as shown, part of cable 216 is in contact with bleed circuit conductors 204 when contacts 220 are engaged with contacts 208. The portion of cable 216 in contact with bleed circuit conductors 204 does not include contacts 208. Allowing the portion of cable 216 to contact bleed circuit conductors 204 may facilitate the removal of cable 216. For example, if bleed circuit conductors 204 are configured like bleed circuit conductors 4 of FIGS. 1A and 1B, allowing bleed circuit conductors 204 to remain at least partially deflected when contacts 220 are engaged with contacts 208 facilitates the removal of cable 216 from connector assembly 200. It should be appreciated, however, that cable 216 may also be configured such that substantially no part of cable 220 overlies bleed circuit conductors 204 when contacts 220 are engaged with contacts 208.

Referring next to FIG. 3, one method of inserting a cable into a connector assembly that includes bleed circuit conductors, and includes and/or is coupled to a bleed circuit, will be described in accordance with an embodiment of the present invention. A process 301 of inserting a cable into a connector assembly that includes bleed circuit conductors begins at step 305 in which contacts that are a part of a cable assembly contact bleed circuit conductors of a connector assembly. Once the contacts on the cable assembly come into contact with the bleed circuit conductors on the connector assembly, if there is stored up electrical charge on the cable assembly, an ESD event may effectively occur in that stored up electrical charge is bled out through a bleed circuit in step 309. As will be appreciated by those skilled in the art, a bleed circuit is a circuit that will allow current to flow from the cable assembly. Hence, as electrical charge is bled out, a current will typically propagate across components of the bleed circuit such that energy that was on the cable assembly is substantially dissipated.

After stored up electrical charge, if any, is bled out, or otherwise discharged from the cable, the contacts on the cable assembly come into contact with the contacts on the connector assembly in step 313. In one embodiment, when the contacts on the cable assembly contact or engage the contacts on the connector assembly, the connector assembly is effectively mated with the cable assembly. The process of inserting the cable assembly into the connector assembly is completed when the contacts on the cable assembly contact the contacts on the connector assembly.

In general, an RJ connector assembly has been described as a modified connector, e.g., a modified connector port or jack, that substantially integrally includes bleed circuit conductors. As discussed above with respect to FIGS. 1A, 1B, and 2, a modified RJ connector may have substantially the same footprint as a standard RJ connector, or a modified RJ connection may have a bigger footprint. A modified RJ connector that has a standard footprint, and therefore does not utilize more space than a standard RJ connector, may be used to retrofit substantially any equipment which uses a standard RJ connector.

Bleed circuit conductors may be added to a standard RJ connector through the use of an adapter mechanism. By way of example, an RJ connector assembly may include a standard RJ connector that is interfaced with an adapter that includes bleed circuit conductors and a bleed circuit. That is, an RJ connector assembly may effectively be formed by augmenting a standard RJ connector with an adapter. Such an adapter, i.e., an adapter within which a bleed circuit is contained, may be used to provide a standard RJ connector, as for example a standard RJ connector that is already installed in electronic equipment, with discharge capabilities or ESD protection.

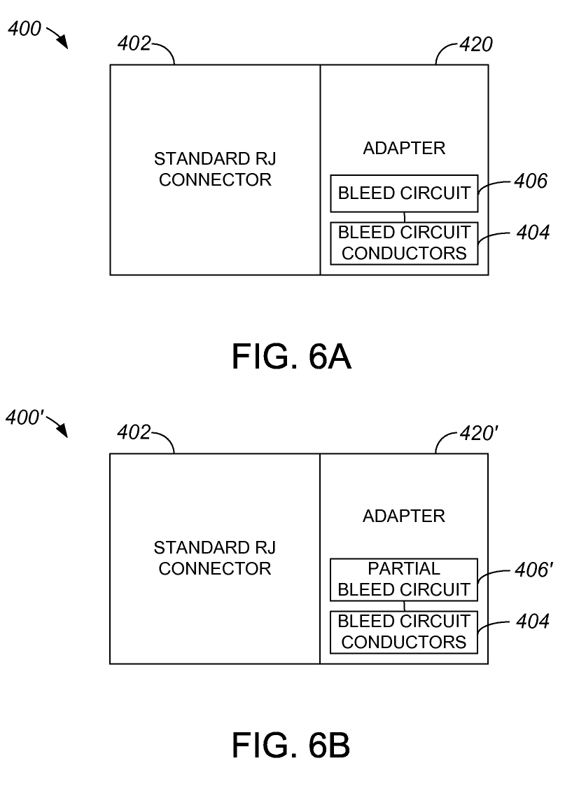

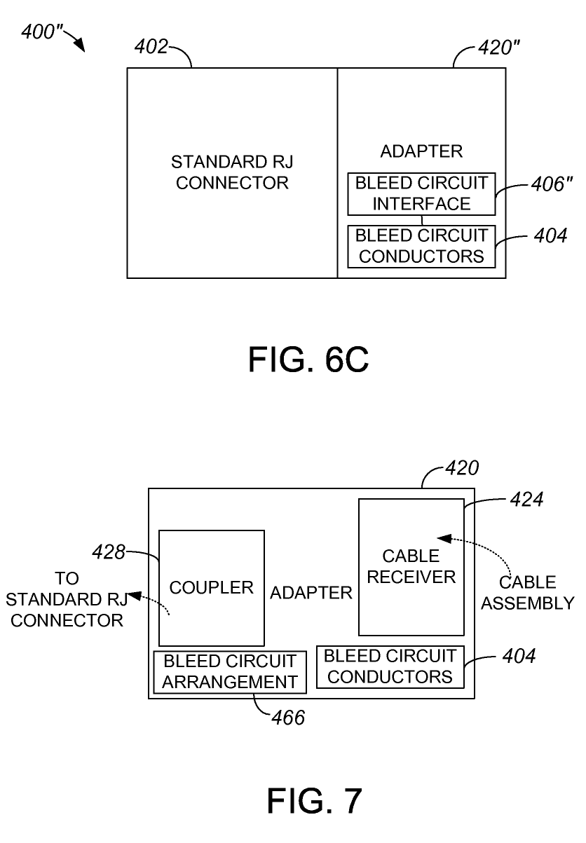

FIG. 6A is a block diagram representation of an RJ connector assembly which includes a standard RJ connector and an adapter with bleed circuit conductors as well as a bleed circuit in accordance with an embodiment of the present invention. A connector assembly 400 includes a standard connector 402, e.g., an unshielded RJ connector without integral bleed circuit conductors, and an adapter 420 that includes bleed circuit conductors 404 and a bleed circuit 406. When standard connector 402 and adapter 420 are coupled or otherwise interfaced, contacts on a cable assembly (not shown) that is to be engaged by standard connector 402 come into contact with bleed circuit conductors 404 prior to being engaged within standard connector 402. Hence, when a cable assembly (not shown) comes into contact with bleed circuit conductors 404, any charges stored up in the cable assembly may be discharged using bleed circuit 406.

It should be appreciated that although an adapter that is suitable for use with a standard RJ connector may integrally include, or otherwise contain, a discharge or bleed circuit, an adapter may instead include either a portion of an overall bleed circuit or no part of an overall bleed circuit. By way of example, if a piece of equipment that is to use an adapter has available space on a printed circuit board, at least a portion of the bleed circuit may be contained on the printed circuit board.

FIG. 6B is a block diagram representation of an RJ connector assembly which includes a standard RJ connector and an adapter with bleed circuit conductors as well as a partial bleed circuit in accordance with an embodiment of the present invention. A connector assembly 400′ includes a standard connector 402 and an adapter 420′ that includes bleed circuit conductors 404 and a partial bleed circuit 406′, i.e., components that are associated with an overall a bleed circuit. Contacts on a cable assembly (not shown) that is to be engaged by standard connector 402 come into contact with bleed circuit conductors 404 prior to being engaged within standard connector 402. When contacts on the cable assembly (not shown) come into contact with bleed circuit conductors 404, charges accumulated in the cable assembly may pass through bleed circuit conductors 404 to an overall bleed circuit that includes partial bleed circuit 406′, as well as other bleed circuit components (not shown), e.g., components included on a printed circuit board that is communicably coupled to partial bleed circuit 406′.

As previously mentioned, an adapter may be arranged such that the adapter includes effectively no discharge or bleed circuitry. Such an adapter may be used in conjunction with a discharge or bleed circuit formed on a printed circuit board to which an overall RJ connector assembly is mounted or otherwise coupled. That is, an adapter that does not include a bleed circuit may be coupled to a substantially external bleed circuit. FIG. 6C is a block diagram representation of an RJ connector assembly which includes a standard RJ connector and an adapter with bleed circuit conductors as well as a bleed circuit interface in accordance with an embodiment of the present invention. A connector assembly 400″ includes a standard connector 402 and an adapter 420″ that includes bleed circuit conductors 404 and a bleed circuit interface 406″, i.e., an interface that provides contact and/or an electrical path from bleed circuit conductors 404 to an external bleed circuit. When contacts on a cable assembly (not shown) come into contact with bleed circuit conductors 404, charges accumulated in the cable assembly may pass through bleed circuit conductors 404 through bleed circuit interface 406″ to an external bleed circuit.

Typically, an adapter includes a receptacle that allows a cable assembly to be passed therethrough, and a coupler that allows the adapter to be coupled to a standard connector. With reference to FIG. 7, one embodiment of an adapter, e.g., adapter 420 of FIG. 6A, will be described in accordance with an embodiment of the present invention. An adapter 420 includes bleed circuit conductors 404 and a cable receiver 424 that is arranged to receive a cable assembly. Cable receiver 424 may be, in one embodiment, an opening in adapter 420 that allows a cable to be inserted into a standard connector that is coupled to adapter 402 through a coupler 428. The configuration of coupler 428 may vary widely. By way of example, coupler 428 may effectively be a female end that is arranged to be coupled to standard connector 402, which may serve as a male end. Alternatively, coupler 428 may be an adhesive that is arranged to adhere to standard connector 402.

Adapter 420 also includes a bleed circuit arrangement 466. Bleed circuit arrangement 466 may be an actual bleed circuit, such as bleed circuit 406 of FIG. 6A, or a portion of a bleed circuit, such as portion of bleed circuit 406′ of FIG. 6B. Alternatively, bleed circuit arrangement 466 may be an interface, e.g., interface 406″ of FIG. 6C, that allows bleed circuit conductors 404 to be electrically and/or physically coupled to an external bleed circuit.

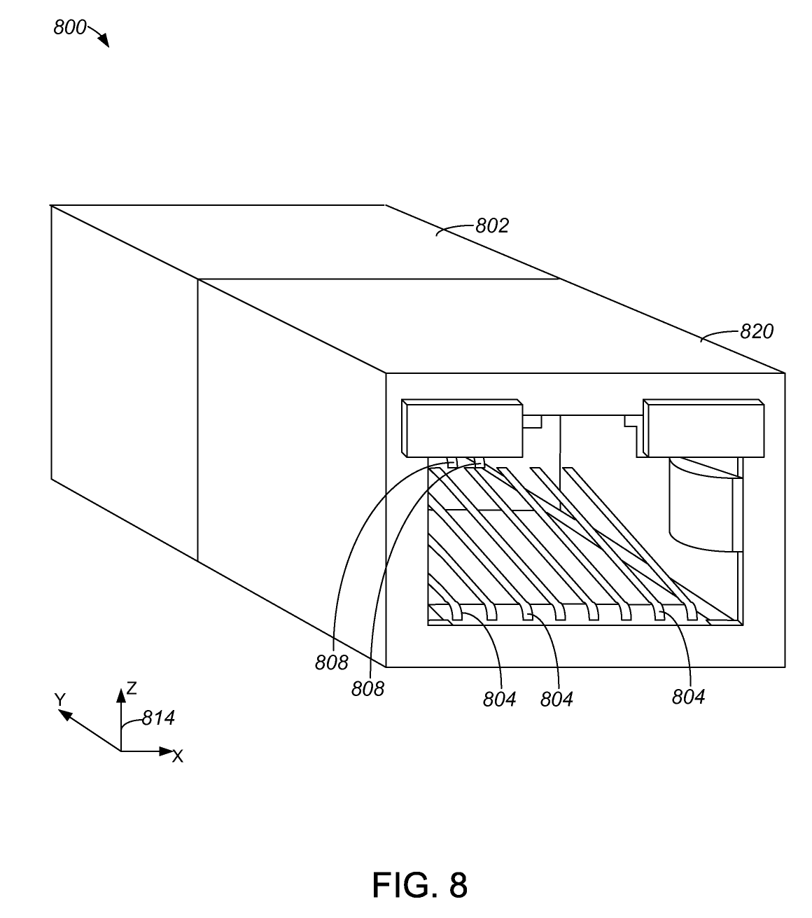

An adapter that is associated with a bleed circuit may have a variety of different configurations. Referring next to FIG. 8, one configuration of an RJ connector assembly which includes an adapter will be described in accordance with one embodiment of the present invention. A connector assembly 800 includes a standard connector 802 and an adapter 820. It should be appreciated that standard connector 802, in one embodiment, may be augmented such that adapter 820 may be coupled with standard connector 802. By way of example, standard connector 802 may be modified to receive an adhesive that is suitable for bonding adapter 820 to standard connector 802.

Standard connector 802 includes contacts 808 that are configured to engage contacts of a cable assembly (not shown) when the cable assembly is inserted into standard connector 802, as previously mentioned. Adapter 820 includes bleed circuit connectors 804 which are configured to be in communication with dispatch or bleed circuitry (not shown). Such bleed circuitry may be contained in adapter 820, partially contained in adapter 820, or contained on a printed circuit board that is substantially external to connector assembly 800. Within connector assembly 800, electrical contacts of a cable (not shown) that is to be engaged by standard connector 802 come into contact with bleed circuit conductors 804 prior to coming into contact with contacts 808.

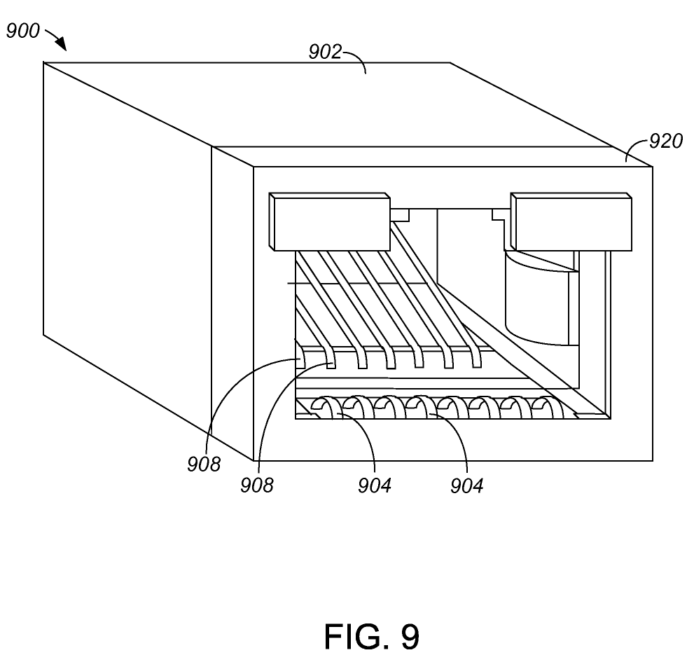

FIG. 9 is a diagrammatic representation of a second embodiment of an RJ connector assembly which includes an adapter in accordance with the present invention. A connector assembly 900 includes a standard connector 902. Standard connector 902 includes contacts 908, and is interfaced with adapter 920. Adapter 920 includes bleed circuit connectors 904 which are in communication with dispatch or bleed circuitry that may be contained in adapter 920, partially contained in adapter 920, or contained on a printed circuit board on which connector assembly 900 is mounted or otherwise supported. Adapter 920 is configured to receive a cable (not shown) such that electrical contacts of the cable come into contact with bleed circuit conductors 904 prior to coming into contact with contacts 908.

Although only a few embodiments of the present invention have been described, it should be understood that the present invention may be embodied in many other specific forms without departing from the spirit or the scope of the present invention. By way of example, the use of bleed circuit conductors to effectively prevent ESD events has been described as suitable in RJ style connectors. However, the use of bleed circuit conductors is not limited to use with RJ style connectors. Other connectors, such as other modular connectors that are used in telecommunications applications, may also utilize bleed circuit conductors. Such modular connectors may include, but are not limited to including, cable jacks such as CAT style cable jacks. The number of bleed circuit conductors in a connector assembly may vary widely depending upon the requirements of the connector assembly and the configuration of the bleed circuit conductors.

Additionally, the configuration of bleed circuit conductors themselves may vary widely. For instance, a brush arrangement may be used as bleed circuit conductors. Bleed circuit conductors have generally been described as an array of metallized conductors. The configuration of bleed circuit conductors, however, may vary widely. For example, bleed circuit conductors may include a conductive brush that contacts a cable when the cable is being plugged into a connector, or bleed circuit conductors may be formed from a conductive adhesive or epoxy. In general, a bleed circuit element that is arranged to prevent ESD events may be substantially any element of an RJ connector assembly that makes contact with electrical contacts of a cable before the cable is seated within the connector assembly without departing from the spirit or the scope of the present invention.

An RJ connector assembly which includes bleed circuit conductors or pins may be supported on, mounted on, or interfaced with equipment, e.g., equipment that includes printed circuit boards, using any suitable method. For instance, an adhesive may be used to couple an RJ connector assembly to a printed circuit board. Alternatively, a mechanical fastener, e.g., a screw or a clamp, may be used to couple an RJ connector assembly to a printed circuit board. An RJ connector assembly may also be mounted on a printed circuit board by soldering or otherwise attaching pins or legs of the RJ connector assembly to receptacles in the printed circuit board, or by press-fitting the RJ connector assembly into the printed circuit board.

It should be appreciated that although a process of inserting a cable assembly into a connector has generally been described as including an ESD event, a process of disengaging or otherwise unmating a cable assembly from a connector may also include an ESD event. In other words, while bleed circuit conductors on a connector allow contacts of a cable assembly to discharge accumulated charge upon insertion of the cable assembly into the connector, such bleed circuit conductors may also allow accumulated charge on the cable assembly to be discharge upon removing the cable assembly from the connector.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

1. An apparatus comprising:
at least one signal contact;
a housing, the housing being arranged to define a receptacle configured to receive a part of a cable assembly, the at least one signal contact being disposed within the receptacle, wherein the at least one signal contact is configured to contact a first contact of the cable assembly when the cable assembly is received in the receptacle such that a signal may pass between the at least one signal contact and the first contact; and
a discharge circuit arrangement, the discharge circuit arrangement including a bleed circuit, the bleed circuit being contained by housing, the discharge circuit arrangement being at least partially disposed on the housing, wherein the discharge circuit arrangement includes at least one discharge conductor that is arranged to contact and to discharge an electrical charge associated with the first contact through the bleed circuit before the first contact contacts the at least one signal contact.

2-4. (canceled)

5. An apparatus comprising:
at least one signal contact;
a housing, the housing being arranged to define a receptacle configured to receive a part of a cable assembly, the at least one signal contact being disposed within the receptacle, wherein the at least one signal contact is configured to contact a first contact of the cable assembly when the cable assembly is received in the receptacle such that a signal may pass between the at least one signal contact and the first contact; and
a discharge circuit arrangement, the discharge circuit arrangement being at least partially disposed on the housing, wherein the discharge circuit arrangement includes at least one discharge conductor that is arranged to contact and to discharge an electrical charge associated with the first contact through a discharge circuit before the first contact contacts the at least one signal contact, and wherein the housing includes a first portion and a second portion, the first portion being arranged to be coupled to the second portion, the first portion being associated with the at least one signal contact and the second portion being associated with the at least one discharge conductor.

6. The apparatus of claim 5 wherein the first portion is associated with a RJ style connector.

7. The apparatus of claim 5 wherein the housing is unshielded.

8. The apparatus of claim 5 wherein the apparatus is an RJ style connector.

9-19. (canceled)

20. An apparatus comprising:
means for receiving a cable assembly, the cable assembly including at least one contact, wherein the cable assembly includes an accumulated charge;
means for discharging the accumulated charge from the cable assembly using a circuit path, the means for discharging the accumulated charge from the cable assembly including
means for interfacing with the contact, wherein the circuit path is contained within the means for receiving the cable assembly; and
means for communicating a signal through the contact after discharging the accumulated charge from the cable assembly using the circuit path, wherein the means for communicating the signal through the contact are separate from the means for discharging the accumulated charge from the cable assembly using the circuit path.

21. The apparatus of claim 5 wherein the discharge circuit arrangement includes the discharge circuit.

22. The apparatus of claim 5 wherein the discharge circuit arrangement includes at least a first component of the discharge circuit, the at least one component being arranged to cooperate with at least a second component to form the discharge circuit, the at least second component being external to the apparatus.

23. The apparatus of claim 5 wherein the discharge circuit is external to the apparatus and the discharge circuit arrangement includes an interface configured to couple the discharge circuit arrangement to the discharge circuit.

24. An apparatus comprising:
a first portion, the first portion being arranged to define a receptacle configured to receive a part of a cable assembly, at least one signal contact being disposed within the receptacle, wherein the at least one signal contact is configured to contact a first contact of a cable assembly when the cable assembly is received in the receptacle such that a signal may pass between the at least one signal contact and the first contact; and
an adapter portion, the adapter portion being separate from and arranged to be coupled to the first portion, wherein the adapter portion defines an opening through which the cable assembly passes before being received in the receptacle, the adapter portion including a discharge circuit arrangement partially disposed on the housing, the discharge circuit arrangement including at least one discharge conductor that is arranged to contact and to discharge an electrical charge associated with the first contact through a discharge circuit before the first contact contacts the at least one signal contact.

25. The apparatus of claim 24 wherein the discharge circuit arrangement includes the discharge circuit.

26. The apparatus of claim 24 wherein the discharge circuit arrangement includes at least a first component of the discharge circuit, the at least one component being arranged to cooperate with at least a second component to form the discharge circuit, the at least second component being external to the apparatus.

27. The apparatus of claim 24 wherein the first portion is associated with a RJ style connector.

28. The apparatus of claim 1 wherein the bleed circuit is an electrostatic discharge protection circuit.
